(19) United States
(12) Patent Application Publication
(10) Pub. No.: US 2026/0296189 A1
(43) Pub. Date: Oct. 1, 2026

(54) NETWORK-BASED CONNECTED VEHICLE VISUALIZATION ALERTS

(71) Applicant: AT&T Intellectual Property I, L.P., Atlanta, GA (US)

(72) Inventors: Nigel Bradley, Canton, GA (US); Walter Cooper Chastain, Atlanta, GA (US); Sheldon Kent Meredith, Roswell, GA (US); Zhi Cui, Sugar Hill, GA (US)

(73) Assignee: AT&T Intellectual Property I, L.P., Atlanta, GA (US)

(21) Appl. No.: 19/096,215

(22) Filed: Mar. 31, 2025

(51) Int. Cl. B60K 35/235; G06V 20/58; G06V 20/59

(52) U.S. Cl. CPC B60K 35/235; G06V 20/58; G06V 20/597

(57) ABSTRACT

Aspects of the subject disclosure may include, for example, providing, to a server, first sensor data from a first sensor of a first vehicle at a first location, where the providing of the first sensor data enables the server to determine an obscured view area associated with the first vehicle; receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle. Other embodiments are disclosed.

### FIELD OF THE DISCLOSURE

The subject disclosure relates to network-based connected vehicle visualization alerts.

### BACKGROUND

In the realm of vehicular safety, particularly for first responder vehicles, there exists a significant challenge in providing drivers with real-time awareness of hazards that are obscured from their direct line of sight. Traditional methods of hazard detection rely heavily on the driver's ability to visually assess the environment, which can be severely limited by physical obstructions such as buildings, trees, or other vehicles. This limitation poses a substantial risk, as drivers may be unaware of potential dangers lurking in blind spots, leading to accidents and compromised safety.

Basic sensor systems may provide limited data about the immediate surroundings of a vehicle (e.g., a proximity detector), but these systems lack the capability to offer a comprehensive view of hidden hazards. Additionally, these systems do not effectively integrate with advanced technologies to enhance situational awareness or provide intuitive alerts to the driver.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating a system for collaborative navigation using network nodes and sensors in accordance with various aspects described herein.

FIG. 2B is a schematic diagram illustrating the interaction between vehicles, sensors, and a collaborative navigation network node within an environment in accordance with various aspects described herein.

FIG. 2C is a schematic diagram illustrating the interaction between vehicles and a collaborative navigation network node in accordance with various aspects described herein.

FIG. 2D illustrates a view of a road intersection relevant to the augmented reality system in accordance with various aspects described herein.

FIG. 2E is a schematic diagram illustrating the interaction between vehicles and a collaborative navigation network node for augmented reality hazard detection in accordance with various aspects described herein.

FIG. 2F illustrates a real-world scenario depicting a blind spot in a driving environment in accordance with various aspects described herein.

FIG. 2G is a block diagram illustrating the interaction between vehicles and a collaborative navigation network node in accordance with various aspects described herein.

FIG. 2H illustrates a visual representation of vehicle designations in an augmented reality display for hazard detection in accordance with various aspects described herein.

FIG. 2I is a system diagram illustrating the interaction between vehicles and a collaborative navigation network node for augmented reality visualization in accordance with various aspects described herein.

FIG. 2J illustrates a reconstructed view data in an augmented reality display for vehicle designation in accordance with various aspects described herein.

FIG. 2K is a system diagram illustrating the interaction between vehicles, sensors, and a collaborative navigation network node for augmented reality hazard detection in accordance with various aspects described herein.

FIG. 2L illustrates a reconstructed view of an augmented object in a driving scenario in accordance with various aspects described herein.

FIG. 2M illustrates an augmented reality display indicating an all-clear signal in a reconstructed view in accordance with various aspects described herein.

FIG. 2N illustrates a flow chart diagram of a method for providing an unobscured view using sensor data analysis in accordance with various aspects described herein.

FIG. 3 is a block diagram illustrating a virtualized communication network architecture for integrating cloud computing environments with various access technologies.

FIG. 4 is a block diagram illustrating an example computing environment for implementing various aspects of the described technology.

FIG. 5 is a block diagram illustrating a mobile network platform interfacing with various network nodes and devices.

FIG. 6 is a block diagram illustrating the components of a communication device used in the augmented reality system for hazard detection.

### DETAILED DESCRIPTION

The subject disclosure describes, among other things, illustrative embodiments for providing an alert or information to a driver of a vehicle with respect to other vehicles or other hazards (e.g., in motion, stopped or fixed such as a downed-tree limb or an animal crossing a road) that are out of, or obscured from, the driver's view. For example, one or more sensors in locations other than the location of the driver's vehicle can be used to collect data (e.g., images, LiDAR data, etc.) that represent or capture the other vehicles or other hazards (e.g., in two or three dimensions), such that a representation, information and/or alert associated with the other vehicles/hazards can be presented to the driver, which can include via an augmented reality device (e.g., through use of a projected vehicle/hazardous object shown on a window (which can include a windshield) and/or on a display of the vehicle).

In one embodiment, an animated version of the other vehicle or hazardous object may be presented to the driver such as showing the motion of the other vehicle (e.g., animated) through (i.e., overlayed on) an obscured view area (e.g., in real-time or near-real-time) which may relay a better understanding of the situation to the driver. This can result in a driver experience which simulates the ability of the driver to see through obstructions and around corners.

In one or more embodiments, the system and methodology can provide drivers, such as first responders or other drivers, with an augmented reality view of hazards that are otherwise obscured from their direct line of sight, such as vehicles or obstacles hidden behind corners or obstructions (including road construction equipment). This can be achieved in a number of different ways including through a network of sensors (which in some embodiments can operate as a mesh network in exchanging data to provide more complete representations of obscured view areas such as from multiple angles or perspectives), including cameras and LiDAR, which can be positioned on vehicle(s) and in the surrounding environment, and which can collect sensor data (e.g., images and/or LiDAR data) to analyze an obscured view area and/or create a three-dimensional model of the obscured area.

In one embodiment, the system can utilize edge network nodes and/or Artificial Intelligence (AI) to analyze this captured or collected data (which can be in combination with other data including mapping information, road position coordinates, historical information, driver profiles/behavior, weather information, accident information, road conditions, and so forth); identify blind spots; and present a realistic augmented reality display to the driver, allowing them to perceive the environment as if the obstructions were not present. Edge network nodes and/or AI can be utilized to make the system and methodology more efficient including providing hazardous alerts and/or hazardous objects presented by the augmented reality display in a faster manner (e.g., in real-time or near-real-time) which increases the amount of time that a driver has to react to the hazardous situation. However, other embodiments can also utilize other servers and/or other algorithms which may not be edge servers and/or may not include AI.

In one or more embodiments, the system and methodology incorporate haptic and/or audio feedback or stimulus which can be based on gaze monitoring (or can be provided when a hazardous object is detected) to ensure the driver's attention is directed towards important alerts, enhancing safety and situational awareness. This approach not only broadens the driver's field of view beyond visible limits but also integrates seamlessly with existing vehicle technologies and can operate as a mesh network, sharing data across multiple vehicles and sensors to improve decision-making and navigation.

In one embodiment, a tactile notice and/or audio alert can be presented to a driver that is determined to be inattentive or otherwise not satisfying an attention threshold (e.g., determined from monitoring a driver's gaze) even when a hazardous object is not detected. In one embodiment, a risk assessment can be performed for detected hazardous objects to determine a type of notice to be presented, such as a tactile stimulus when another vehicle is detected in the obstructed view area but at a distance which is far enough to be deemed no risk or low risk while an audio alert (which can also be combined with the tactile stimulus) is used for a vehicle that is closer and deemed a higher risk.

In one embodiment, the system and methodology can calculate speed, direction and distance between the hazardous object (e.g., another vehicle, an animal, etc.) and the vehicle receiving the alerts in order to determine the type of alert to be presented and its risk assessment level. In other embodiments, information associated with the driver can further be analyzed as part of the risk assessment, such as known response times, reflexes, historical acceleration and/or braking under various driving conditions such as when approaching an obstructed view area in the past or when driving in particular types of weather.

In one or more embodiments, the system and methodology can seamlessly extend a driver's field of view beyond visible limits providing an improvement to systems including by ensuring safer navigation and decision-making in complex environments. Other embodiments are described in the subject disclosure.

One or more aspects of the subject disclosure include a device, comprising: a processing system including a processor; and a memory that stores executable instructions that, when executed by the processing system, facilitate performance of operations. The operations comprise receiving first sensor data from a first sensor of a first vehicle at a first location; analyzing the first sensor data; and determining, based on the analyzing of the first sensor data, an obscured view area associated with the first vehicle. The operations comprise identifying a second sensor at a second location that has an alternate view of the obscured view area; and obtaining second sensor data from the second sensor at the second location. The operations comprise creating a three-dimensional model of a second vehicle in the obscured view area based at least in part on the second sensor data; and providing a representation of the three-dimensional model to a display device of the first vehicle for presentation at the first vehicle.

One or more aspects of the subject disclosure a method, comprising receiving, by a processing system including a processor, first sensor data from a first sensor of a first vehicle at a first location. The method can include analyzing, by the processing system, the first sensor data to determine an obscured view area corresponding to a potential hazard. The method can include identifying, by the processing system, a second sensor on a second vehicle at a second location positioned to capture an alternate view of the obscured view area. The method can include receiving, by the processing system, second sensor data from the second sensor at the second location; and analyzing, by the processing system, the second sensor data. The method can include detecting, based on the analyzing of the second sensor data, a hazardous object in the obscured view area; determining a risk assessment with respect to the hazardous object, the first vehicle and the obscured view area; and providing data representing the risk assessment to the first vehicle.

One or more aspects of the subject disclosure include a non-transitory machine-readable medium, comprising executable instructions that, when executed by a processing system including a processor, facilitate performance of operations. The operations comprise providing, to a server, first sensor data from a first sensor of a first vehicle at a first location, where the providing of the first sensor data enables the server to determine an obscured view area associated with the first vehicle. The operations comprise receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle.

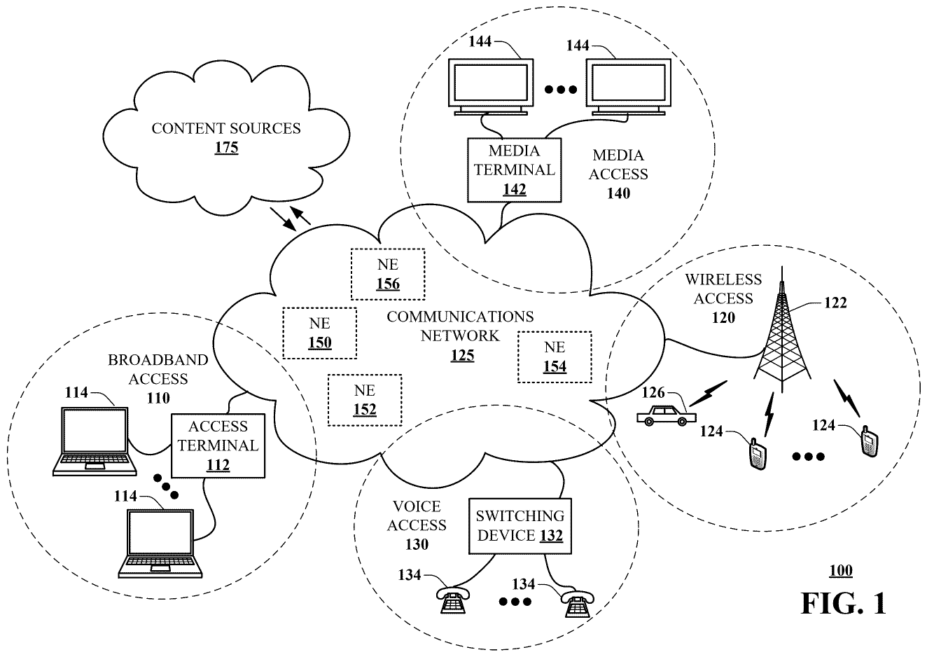

Referring now to FIG. 1, a block diagram is shown illustrating an example, non-limiting embodiment of a system 100 in accordance with various aspects described herein. For example, system 100 can facilitate in whole or in part providing, to a server, first sensor data from a first sensor of a first vehicle at a first location, where the providing of the first sensor data enables the server to determine an obscured view area associated with the first vehicle; receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

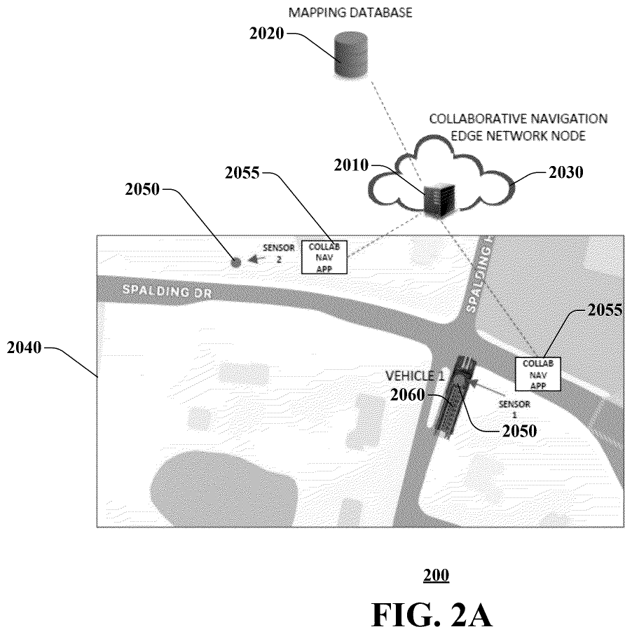

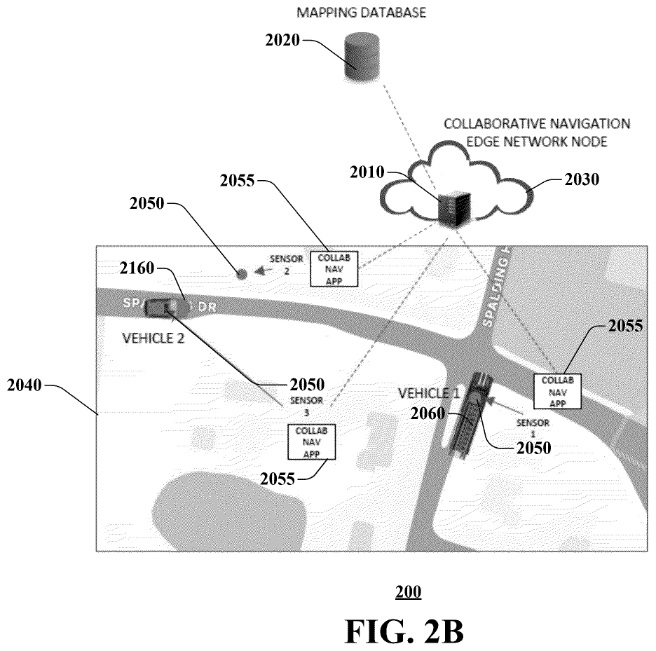

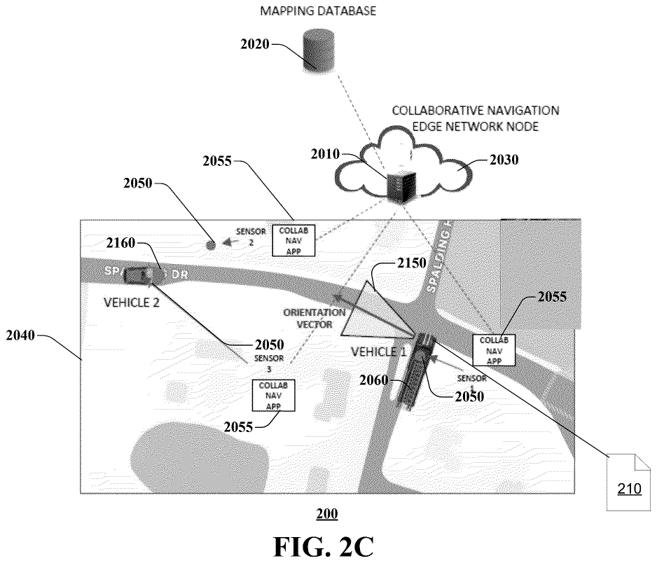

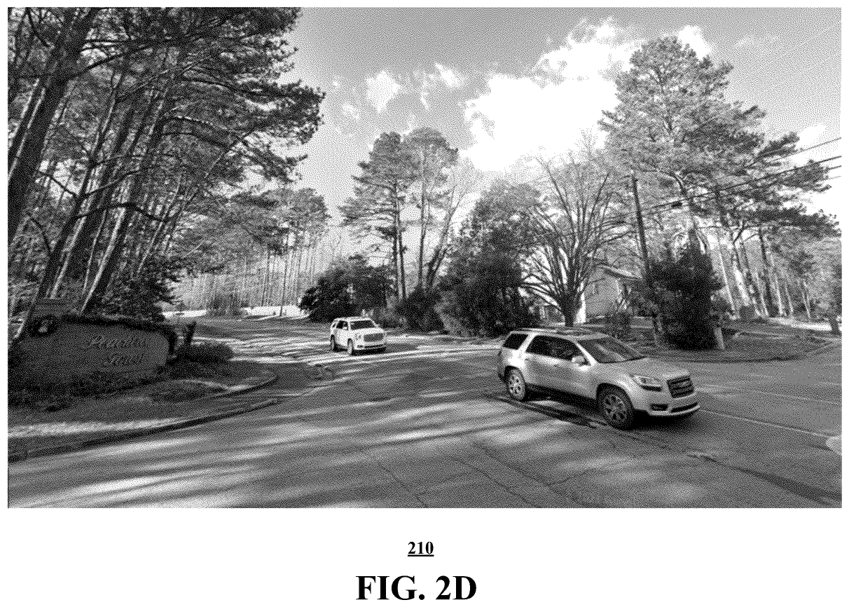

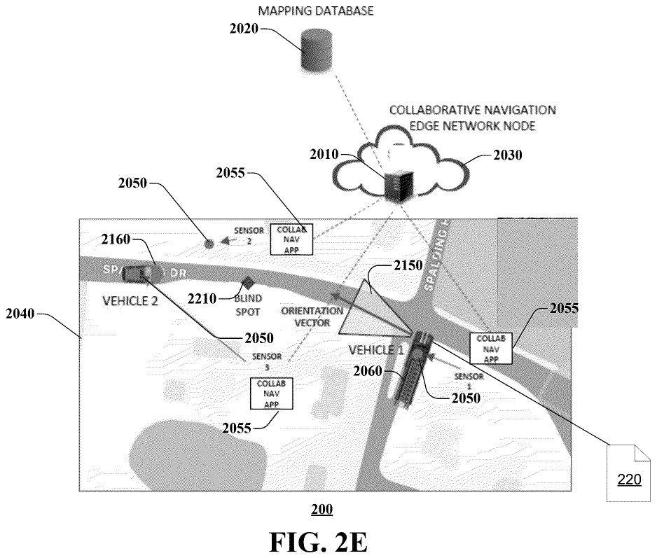

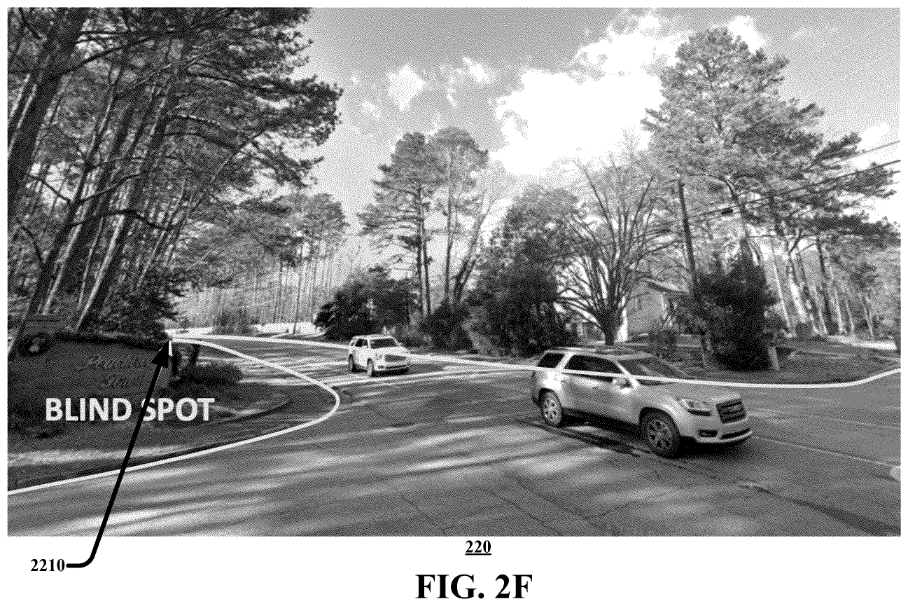

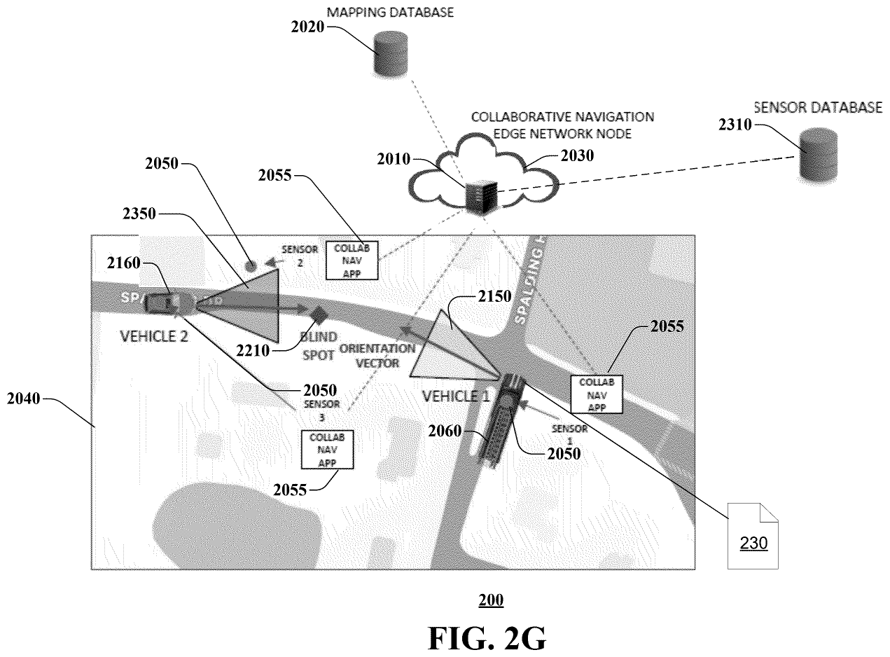

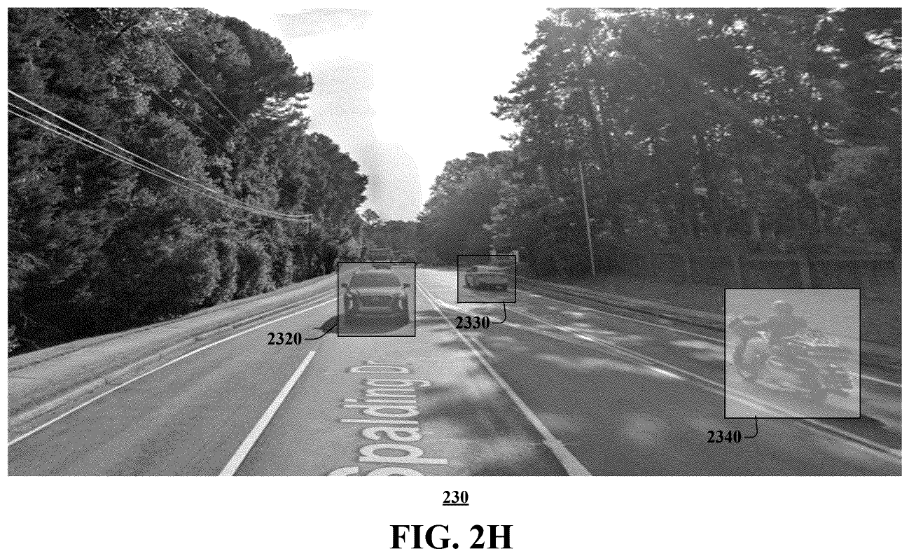

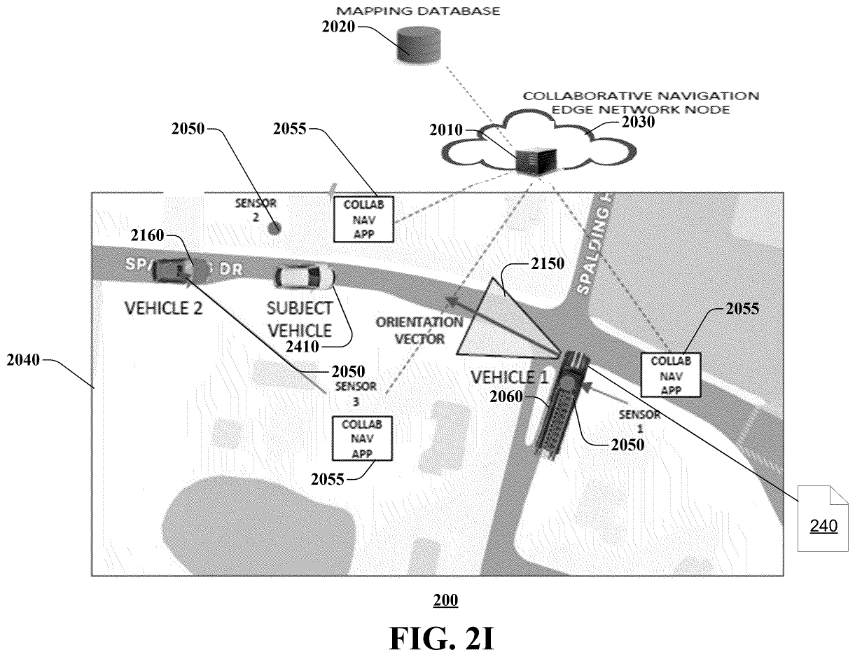

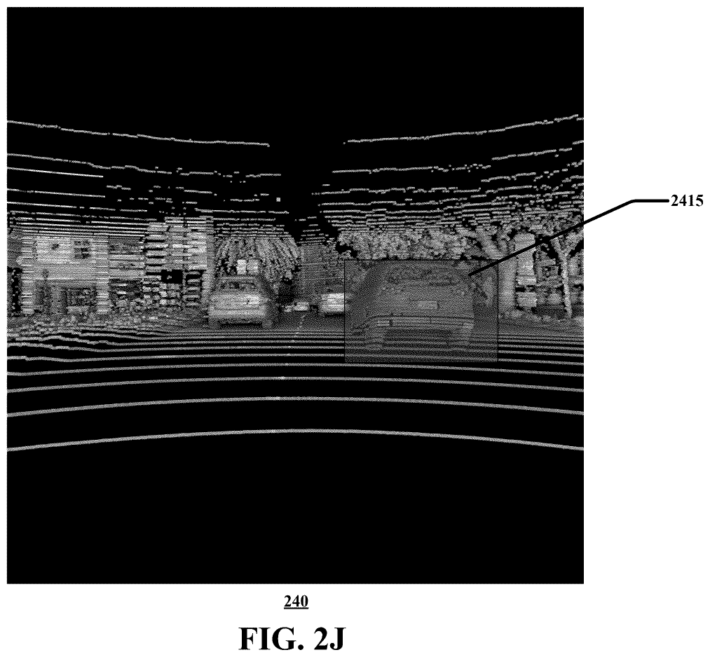

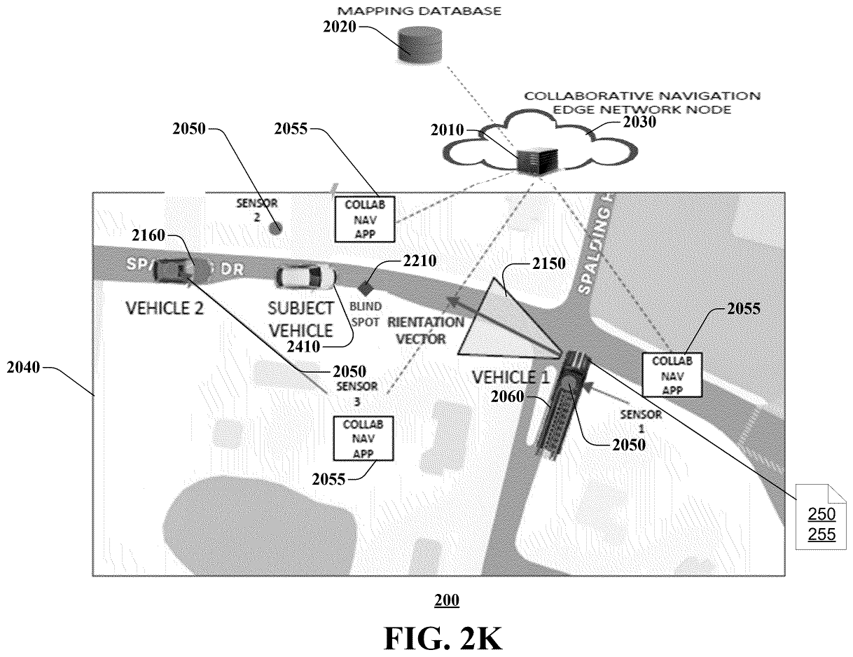

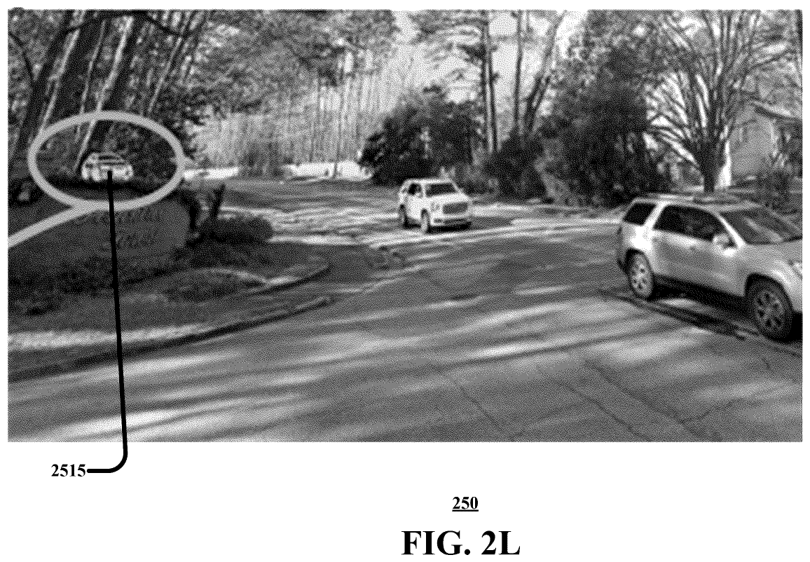

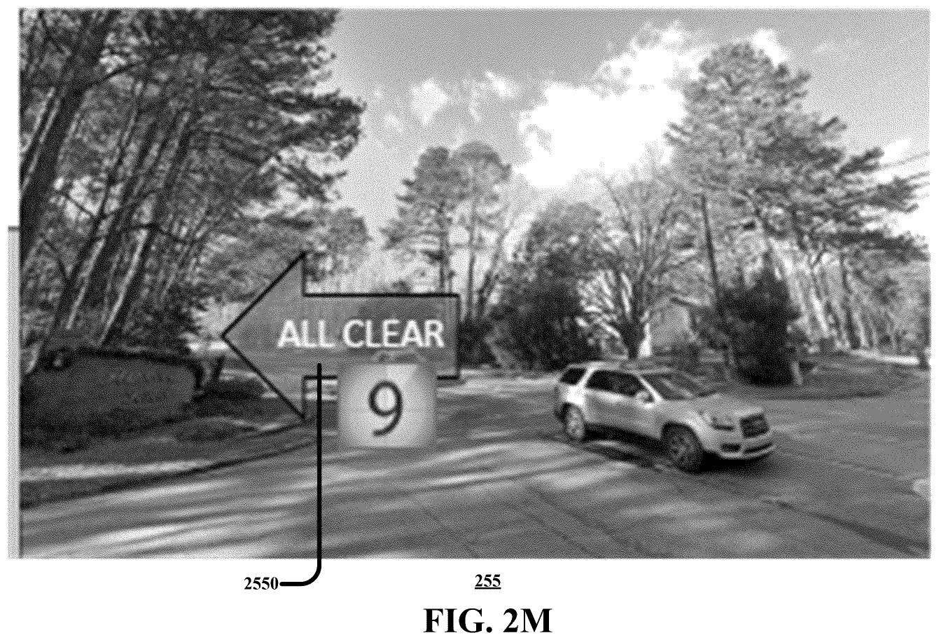

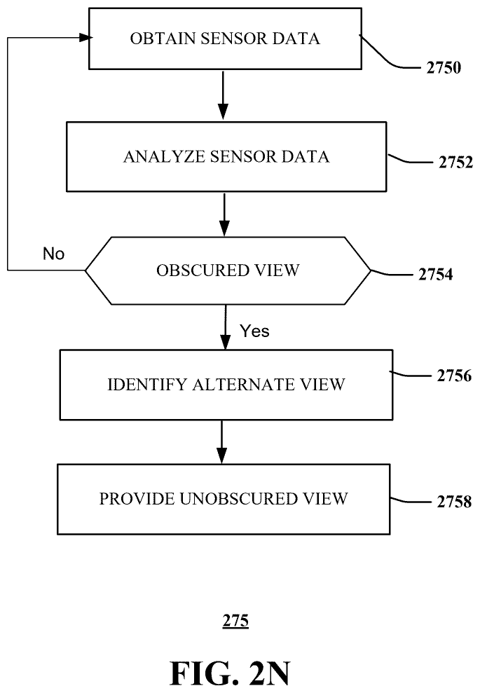

FIG. 2A is a block diagram illustrating a system 200 for collaborative navigation using network nodes (e.g., edge servers/nodes) and sensors in accordance with various aspects described herein.

In one or more embodiments, a vehicle, such as a first responder vehicle, may be equipped with one or more sensors that collect data describing conditions in and around the environment of the vehicle. The sensor(s) may be in communication with a collaborative navigation app of the vehicle (or operating on a communication device in the vehicle), which may in turn be in communication with a collaborative navigation networking node(s). The sensor(s) on the vehicle may be of various types including image cameras, video cameras, LiDAR sensors, sonar sensors, radar sensors, or other sensors that collect data to create a representation of the physical environment surrounding or otherwise external to the vehicle.

FIG. 2A is a block diagram illustrating the system 200 for collaborative navigation using network nodes 2010 (only one of which is shown) and sensors 2050. In this example, a first vehicle 2060 is equipped with a first sensor 2050 and a collaborative navigation app 2055 that collects data about the environment 2040 surrounding the vehicle, which in this case is an intersection of roads but can include any surroundings in which hazardous objects can be in proximity to moving vehicles. The data collected by the first sensor 2050 can be communicated to the collaborative navigation edge network node 2010 operating in a network 2030, which is also connected to a database 2020 (which in this example can include mapping information and can be referred to as a mapping database). The edge network node 2020 can process the collected data (e.g., images and/or LiDAR data) to enhance navigation and situational awareness for the vehicle 2060. The system 200 can integrate data from multiple sensors, including those from other vehicles and/or fixed locations (an example of which is illustrated as a second sensor 2050 positioned alongside a road such as a traffic camera, security camera, etc.), to provide a comprehensive view of the driving environment. This configuration allows the vehicle 2060 to receive augmented reality alerts about potential hazards that may be obscured from the driver's direct line of sight.

In one or more embodiments, the mapping information in the database 2020 can include position information corresponding to a road in the obscured view area, where the position information is used for creating alerts and/or a three-dimensional model associated with an obscured view area.

FIG. 2B is a schematic diagram illustrating the interaction between vehicles, sensors, and a collaborative navigation network node(s) within the system 200 in accordance with various aspects described herein.

In one embodiment, a separate sensor (e.g., second sensor) may exist at another location within the proximate environment of the vehicle where the second sensor can be a fixed sensor or a mobile sensor, such as a sensor on another vehicle. Any number of sensors can be in communication with their own collaborative network app that is in turn in communication with the collaborative navigation network node. For example, each of the sensors can use their native sensing capabilities to collect data describing the environment conditions and can send it to the collaborative navigation network node. In doing so, each sensor can also send data such as a time and location stamp and sensor directional orientation data. For instance, this location and orientation data can be used by the network node in its analysis of the collected data and determination of alerts and/or constructing models representing hazardous objects in an obscured view area.

FIG. 2B is a schematic diagram illustrating the interaction between vehicles 2060, 2160, sensors 2050, and a collaborative navigation edge network node 2010 within the system 200. In this example, the first vehicle 2060 and the second vehicle 2160 are shown, each equipped with sensors 2050 and collaborative navigation apps 2055. These sensors 2050 collect data about the surrounding environment 2040 and communicate this information to the collaborative navigation edge network node 2010. The edge network node 2010 can be connected to the mapping database 2020, which it uses to process the data and enhance navigation and situational awareness for the vehicles including generating alerts and constructing three-dimension models for the obscured view area. This system 200 allows for the integration of data from multiple sensors 2050, providing a comprehensive view of the driving environment and enabling augmented reality alerts for potential hazards that may be obscured from the driver's direct line of sight. The embodiments described herein discuss alerts being provided at the first vehicle 2060 based on sensors 2050 at other locations, such as on second vehicle 2160. However, it should be understood that the flow of data between sensors 2055, vehicle Nav Apps 2055, vehicles 2060, 2160, and/or node 2010 can be in any direction such that drivers of any of the vehicle (or any end user device equipped with App 2055) can receive alerts, three-dimensional models or other information associated with hazardous objects in an obstructed view area. For instance, two vehicles travelling in opposite directions towards each other on a curved road may each be experiencing an obstructed view area and may each receive alerts, three-dimensional models or other information associated with hazardous objects in their respective obstructed view areas (which may be alerts notifying them of each other).

In one embodiment, a perspective of an augmented reality display utilized for presenting alerts and/or a three-dimensional model associated with an obscured view area can be calibrated or otherwise adjusted based on the first vehicle's positional data and/or the driver's head orientation detected by an in-vehicle sensor (e.g., in vehicle 2060). In one embodiment, an augmented display device can include smart glasses worn by the driver such that the alert or three-dimensional model associated with the obscured view area is provided from the vehicle (e.g., vehicle 2060) to the smart glasses. In other embodiments, the alert or three-dimensional model associated with the obscured view area can be presented on a display (e.g., navigation display on a dashboard) of the vehicle. In one embodiment, the exchange of information, including sensor data, can be via a multi-hop or daisy chain technique to expedite sourcing of data. In other embodiments, system 200 can be extended via multiple servers 2030 and a vast number of sensors (fixed and/or mobile) so that the system 200 provides the augmented hazard display service throughout a large geographic area. In one embodiment, sensor types can be selected to obtain a particular type of sensor data, such as where image data or LiDAR data is preferred.

FIG. 2C is a schematic diagram illustrating the interaction between vehicles and a collaborative navigation network node within the system 200 in accordance with various aspects described herein. This can include a determination of a vehicle location vector from a first vantage point. As an example, a first vehicle sensor may be a video camera that collects data describing a video image and sends it, along with data indicating the location of the sensor, the time and date of the sensor data collection, and the directional orientation of the sensor in capturing the video image. This data may be sent to the collaborative navigation network node. In one embodiment, the data collected may be analyzed by the network node for the purposes of aiding in navigation of a vehicle. In particular, the collaborative navigation app may send this data to the network node so that the network node may engage data from other collaborative sensors to assist in vehicle navigation. In one or more embodiments, this methodology can be applied to self-driving cars where alerts, information or modeling are presented to the computing system of the self-driving car for analysis, which may result in a change of operational behavior, such as slowing down or waiting longer at an intersection.

FIG. 2C illustrates the interaction between vehicles 2060, 2160 and a collaborative navigation edge network node 2010 within the system 200. In this example, the first vehicle 2060 and the second vehicle 2160 are depicted, each equipped with sensors 2050 and collaborative navigation apps 2055 so that the sensors can collect or otherwise capture data about the environment 2040 and transmit this information to the node 2010. The node 2010 can be connected to the mapping database 2020, which aids in processing the data to improve navigation and situational awareness for the vehicles. Additionally, an orientation vector 2150 is illustrated, which represents the directional orientation of the sensors 2050 of the first vehicle 2060, facilitating the determination of obscured view areas and the identification of other sensors that can provide alternate views. For example, the vector 2150 can provide bounds or otherwise be utilized to determine an area where blind spots are to be analyzed and sensors are to be identified. This configuration enables the vehicles 2060 (and/or 2160) to receive augmented reality alerts or information (shown by information 210) about potential hazards that may be hidden from the driver's direct line of sight.

FIG. 2D illustrates a view 210 of a road intersection relevant to the augmented reality system 200 in accordance with various aspects described herein. This example provides a real-world context for the system's application, showcasing a typical driving environment where the augmented reality system 200 can be utilized to detect and alert drivers to potential hazards that may be obscured from their direct line of sight. The intersection depicted serves as an example of a location where obstructions, such as trees or buildings, could block a driver's view, highlighting the importance of the system in enhancing situational awareness and safety.

FIG. 2E is a schematic diagram illustrating the interaction between vehicles and a collaborative navigation network node for augmented reality hazard detection within the system 200 in accordance with various aspects described herein. This can include a determination or detection of an obscured view(s) for any number of vehicles. For example, the network node may analyze the sensor data, such as the video image, using artificial intelligence techniques to make a determination of visibility conditions for a driver(s) of any of the vehicles.

In one embodiment, artificial intelligence may determine the location of road surfaces in relation to a vehicle and identify where road surfaces become obscured from view nearby. For example, a point where road surfaces converge may indicate a blind spot. The network node may acquire mapping data from a mapping database to make an estimate of the distance of the blind spot from a vehicle(s). If the blind spot is within a threshold distance from a vehicle(s), the obscured view may be identified as an obscured view of interest or obscured view area.

FIG. 2E is a schematic diagram illustrating the interaction between vehicles and a collaborative navigation network node for augmented reality hazard detection within the system 200. In this example, a first vehicle 2060 and a second vehicle 2160 are shown, each equipped with sensors 2050 and collaborative navigation apps 2055. These sensors gather data about the surrounding environment 2040 and communicate this information to a collaborative navigation edge network node 2010. The edge network node 2010 is connected to a mapping database 2020, which it uses to process the data and enhance navigation and situational awareness for the vehicles. In one embodiment, a blind spot 2210 can be identified as described herein and an orientation vector 2150 can further be determined for the vehicle 2060 and/or its sensor 2050, which are used to identify areas that may be obscured from the driver's view and/or areas where available sensors are to be identified. This configuration enables the vehicles 2060 (and/or 2160) to receive augmented reality alerts, information, models and so forth (shown by information 220) about potential hazards that may be hidden from the driver's direct line of sight thereby improving safety and decision-making. In one or more embodiments, the exchange of data and/or receiving the analysis information from the node 2010 can enable a vehicle (e.g., vehicle 2060) to perform a mitigation action, such as slowing down or stopping. In one embodiment, vehicle 2060 can be a self-driving vehicle and the mitigation action can include an adjustment to control over the vehicle as described herein. In another embodiment, three-dimensional modeling, augmented reality alerts or other information can be exchanged between vehicles, including directly between vehicles 2060 and 2160 and/or between vehicles 2060 and 2160 through use of network elements of network 2030 which may or may not be different from node 2010.

FIG. 2F illustrates a real-world scenario depicting a blind spot 2210 in a driving environment within the system 200 in accordance with various aspects described herein. This example provides a visual representation of how certain areas on the road can be obscured from a driver's direct line of sight due to physical obstructions, such as trees or buildings. The highlighted blind spot emphasizes the importance of the augmented reality system 200 in identifying and alerting drivers to potential hazards that may be hidden in these areas. By enhancing situational awareness, the system 200 aims to improve safety and assist drivers in making informed decisions while navigating complex environments. In one embodiment, the blind spot 2210 can be presented via an augmented display device, such as through text, colored lines, etc. that are presented on a window or windshield of the vehicle to let the driver know that a blind spot exists (even in situations that a hazardous object is not detected in the obscured view area).

FIG. 2G is a block diagram illustrating the interaction between vehicles and a collaborative navigation network node within the system 200 in accordance with various aspects described herein. This can include an identification of a proximate or alternative view (e.g., a view that is unobstructed or has less obstruction) or an assistant sensor(s).

In one or more embodiments, sensors (and/or vehicles with sensors) can be registered in a sensor database. Data associated with their database records may include information about the sensors, such as their capabilities (e.g., images vs LiDAR), location, orientation, and/or movement/acceleration/speed for mobile sensors. Accordingly, when a network node identifies an obstructed view of interest for a vehicle, it may search for one or more other sensors in a direction consistent with the orientation vector of the sensor. These assistant sensors can be identified as having a position to collect sensor data from an alternate vantage point for the location of the blind spot. In one embodiment, a sensor on a vehicle may be a video camera. It may return data to the network node describing video in the direction of the blind spot from the vantage point of another vehicle. In other embodiments, sensor data may be collected from multiple alternative views and the information merged or otherwise utilized together to generate the transparent view for a driver through an obscured view area.

FIG. 2G is a block diagram illustrating the interaction between vehicles 2006, 2160 and a collaborative navigation network node 2010 within the system 200 where sensors 2050 collect data about the surrounding environment 2040 and communicate this information to the node 2010 which is connected to the mapping database 2020 and the sensor database 2310, which it uses to process the data and enhance navigation and situational awareness for the vehicles. FIG. 2G depicts an orientation vector 2150 and a blind spot 2210, which are used to identify areas that may be obscured from the driver's view, such as the driver of vehicle 2060. This configuration allows the vehicles to receive augmented reality alerts for potential hazards (illustrated as information 230) that may be hidden from the driver's direct line of sight, thereby improving safety and decision-making. An orientation vector 2150 with respect to the blind spot 2210, can be used to identify areas that may be unobscured from the sensor 2050 of the second vehicle 2160.

FIG. 2H illustrates a visual representation of vehicle designations 2320, 2330, 2340 in an augmented reality display for hazard detection within the system 200 in accordance with various aspects described herein. As an example, a network node may analyze data from a sensor on a vehicle and identify, in this case, another vehicle that is obscured from view of a vehicle having an obstructed view, but within a threshold distance such that it is in the obscured view of interest. Other vehicles within the obscured view area may be designated as either approaching the obscured view area, or not a risk, based on their speed, location, and/or direction of travel, as they relate to the location of a vehicle experiencing the obscured view area.

FIG. 2H illustrates a visual representation of vehicle designations in an augmented reality display for hazard detection within the system. The example shows different vehicles on a roadway, each designated with visual markers to indicate their status or relevance to the driver. Vehicle designations 2320, 2330, and 2340 are used to identify and categorize vehicles based on factors such as their proximity, speed, and direction of travel relative to the observing vehicle. This augmented reality display helps drivers quickly assess potential hazards and make informed decisions by providing a clear and intuitive visualization of the driving environment. The vehicle designations 2320, 2330, and 2340 (and others) can be presented in an augmented reality display, such as projected on a window/windshield or shown on a dashboard display, or in other embodiments these designations can be received by and utilized by the vehicle 2160 and presented in a fashion as controlled by the vehicle (e.g., via user customization), such as only depicting high risk vehicles and not low risk vehicles, etc.

FIG. 2I is a system diagram illustrating the interaction between vehicles and a collaborative navigation network node for augmented reality visualization within the system 200 in accordance with various aspects described herein. This can include receipt of assistant sensor data (e.g., LiDAR) from a second vantage point. In another embodiment, a vehicle may employ a LiDAR sensor as yet another sensor to collect a set of data points that represent the subject vehicle as a three-dimensional object in space. More specifically, the representation of the subject vehicle can be represented as a three-dimensional object as it relates to the vantage point of the LiDAR sensor of the particular vehicle with an unobscured view. For example, a vehicle identified as having an unobscured view can send the LiDAR data representation of a high risk subject vehicle (i.e., vehicle with an obscured view area that is travelling at a speed/acceleration and direction that is assessed to be of high risk to another vehicle) to the network node so that an alert or model can be provided to the other vehicle that is experiencing the obscured view.

This example can include extrapolation of sensor data to a three-dimensional object view where a network node receives the three-dimensional representation of the subject vehicle along with data from a vehicle sensor that describes the location of a vehicle capturing the data (i.e., the unobscured view), and therefore the relative location of all LiDAR data points of the subject vehicle are known to the network node. For instance, the network node can use artificial intelligence techniques to extrapolate a complete three-dimensional model of the subject vehicle, with each data point of the model represented as a three-dimensional point in space. Therefore, the network node has knowledge of an approximation of every (or most) three-dimensional points of the complete model of the subject vehicle at any point in time.

FIG. 2I is a system diagram illustrating the interaction between vehicles and a collaborative navigation edge network node for augmented reality visualization within the system 200. In this example, the first vehicle 2060 and the second vehicle 2160 are shown, each equipped with sensors 2050 and collaborative navigation apps 2055, where the sensors collect data about the surrounding environment 2040 and communicate this information to a collaborative navigation edge network node 2010. The network node 2010 can be connected to the mapping database 2020, which it uses to process the data and enhance navigation and situational awareness for the vehicles. The subject vehicle 2410 and the orientation vector 2150, can be used to create reconstructed view data 240. This configuration allows the vehicles to receive augmented reality visualizations of potential hazards, providing drivers with a comprehensive view of the driving environment and improving safety and decision-making.

In one or more embodiments, AI can be applied to various information including collected data from sensors 2050, as well as historical data, weather conditions, historical accidents, driver's capability, vehicle dimensions, vehicle capabilities, vehicle shapes, vehicle blind spots, and so forth, which can be utilized to assess, evaluate or categorize a level of risk associated with an obscured view area. In one embodiment, alerts, three-dimensional models, or other information (including a vehicle object overlay presented via projection by an augmented reality display device/projector) can be based on and situated/positioned according to a driver's height, sitting position, and so forth to more accurately or realistically reflect a transparent view being provided to a driver for an obstructed or obscured view area.

FIG. 2J illustrates reconstructed view data in an augmented reality display for vehicle designation within the system 200 in accordance with various aspects described herein, which can include a vehicle designation 2415 generated by the system 200. This example showcases how the system 200 uses data collected from various sensors (e.g., LiDAR sensors) to create a three-dimensional representation of the driving environment. The reconstructed view 240 is used to provide drivers with a visual representation of vehicles and potential hazards that may be obscured from their direct line of sight. In one embodiment, the vehicle designation 2415 highlights specific vehicles within the augmented reality display, allowing drivers to quickly identify and assess the relevance and risk associated with each vehicle. This visualization aids in enhancing situational awareness and supports safer driving decisions. For example, the designation 2415 can be limited to vehicles that are deemed higher risk (e.g., due to distance, speed and direction) with respect to a vehicle experiencing an obscured view. Various techniques can be utilized for designating particular vehicles within an augmented reality display such as color coding. In other embodiments, the reconstructed view data 240 which can be derived from LiDAR data collected by a LiDAR sensor (e.g., vehicle 2160 which is behind the target vehicle 2410) can be analyzed and utilized to generate an augmented reality alert or model that the driver of vehicle 2060 can be shown which can be presented from the perspective of the driver's view, such as showing the target vehicle 2410 that is designated by reference 2415 as travelling towards the driver of the vehicle 2060 rather than travelling away as shown from the perspective of vehicle 2160.

FIG. 2K is a system diagram illustrating the interaction between vehicles, sensors, and a collaborative navigation network node for augmented reality hazard detection within the system 200 in accordance with various aspects described herein. This can include presentation via extrapolation of a first vantage point for the driver of vehicle 2060. For example, with knowledge of every or numerous points of a three-dimensional model of the subject vehicle known (via the collected sensor data), the network node 2010 may send to vehicle 2060 data representing the model of the subject vehicle 2410 to be presented at vehicle 2060 from the vantage point of vehicle 2060. Vehicle 2060 may use this data to alert the driver of the presence of the subject vehicle 2410. In one embodiment, an augmented reality display, for example, projecting a representative image on a window/windshield in vehicle 2060 may also present it as an animated image representation of the subject vehicle 2410 at the position of the subject vehicle based on the data provided by the sensor 2050 of the vehicle 2160. This animated image may be presented, for instance, as though the driver has the ability to see through the obstruction, which otherwise prohibits the driver from seeing the subject vehicle 2410.

FIG. 2K is a system diagram illustrating the interaction between vehicles 2060, 2160, 2410, sensors 2050, and a collaborative navigation edge network node 2010 for augmented reality hazard detection within the system 200. In this example, the first vehicle 2060 and the second vehicle 2160 are depicted, each equipped with sensors 2050 and collaborative navigation apps 2055 whereby these sensors collect data about the surrounding environment 2040 and communicate this information to the network node 2010. The network node 2010 can be connected to the mapping database 2020, which it uses to process the data and enhance navigation and situational awareness for the vehicles. FIG. 2K also illustrates the subject vehicle 2410, the blind spot 2210, and the orientation vector 2150, which are used to identify and visualize areas that may be obscured from the driver's view (of vehicle 2060). This configuration allows the vehicles to receive augmented reality alerts for potential hazards that may be hidden from the driver's direct line of sight, thereby improving safety and decision-making.

FIG. 2L illustrates a reconstructed view of an augmented object 2515 in a driving scenario within the system 200 in accordance with various aspects described herein. This example demonstrates how the system 200 uses data from various sensors 2050 (shown in FIG. 2K) to create an augmented reality display that includes a reconstructed view 250 with any objects (e.g., 2515) that may be obscured from the driver's direct line of sight. The augmented object 2515 is visually represented within the reconstructed view 250, providing the driver with enhanced situational awareness. This visualization allows the driver to perceive potential hazards or objects in the driving environment as if there were no obstructions, thereby improving safety and aiding in informed decision-making while navigating complex scenarios. The augmented object 2515 can be selected to represent or be similar to the target vehicle 2410 (e.g., an icon that resembles the type of vehicle) or other hazardous object that it is intended to represent. In some embodiments, additional information can be provided to further enable the driver to under the risk and assess the situation, such as describing the hazardous object in text or via audio such as “a dump truck is approaching through the obscured view area and has been determined to be high risk.”

In one embodiment, the presentation of the three-dimensional model or other information that is generated as an alert or indicator for the driver based on the collected data from sensors having an unobscured view, can be presented on a window (which can include a windshield) of the vehicle at a window location corresponding to a line of sight of a driver to the obscured view area. For example, the window presentation of the augmented reality can be a reflection from a projector or other display device which has the ability to adjust a position (e.g., in real-time or near-teal-time) of the reflection with respect to the surface on which it is being displayed. As such, the augmented display device can provide a more realistic representation of a target vehicle that is passing through the obscured view area. In one embodiment, the window location for the presentation of the augmented reality display can be adjusted based on various factors including a height of the driver.

FIG. 2M illustrates an augmented reality display indicating an all-clear signal in a reconstructed view 255 within the system 200 in accordance with various aspects described herein. The augmented reality presentation may be presented when a lack of competing vehicles are detected. In this example, an all clear message or indicator 2550 may be presented as the augmented reality presentation. In another embodiment, a countdown may be presented representing time until the next detected vehicle is predicted to arrive based on data collected by vehicle sensors having an unobstructed view or other sensors that are registered and found to be directionally consistent with the orientation vehicle vector for the particular sensor. Such a solution may enable the driver to have enough information available from these collaborative alerts, to allow the driver to proceed without having a visible view of other vehicles or other hazards.

FIG. 2N illustrates a flow chart diagram of a method 275 for providing an unobscured view using sensor data analysis in accordance with various aspects described herein. The process begins with obtaining sensor data at 2750 from one or more sensors positioned on or around a vehicle, which is seeking or being provided with an augmented reality alert service. The vehicle can be of various types, such as passenger cars, first responder vehicles, and so forth. This collected data is then analyzed at 2752 to assess the current environmental conditions and identify any potential obstructions. A decision point is reached to determine whether an obscured view exists at 2754. If no obscured view is detected, the process may loop back to continue obtaining sensor data. However, if an obscured view is identified, the method 275 proceeds to identify one or more alternate views at 2756 using data from one or more other sensors that can provide a different perspective of the obscured area. This can include fixed sensors, such as a traffic camera, a security camera or some other fixed sensor device. In other embodiments, this can include mobile sensors, such as cameras or LiDAR sensors connected to other vehicles. In one embodiment, these sensors and/or the vehicles can be registered with a database to facilitate identifying other sensors with an alternative view. In one embodiment, locations of other vehicles can be determined to detect whether the particular location provides an alternative view of an obscured viewing area. The method can provide an unobscured view at 2758 to a driver, such as through an augmented reality display, allowing the driver to perceive the environment as if the obstructions were not present. This presentation can be done in a number of different ways including via a projection on to a window including a windshield, via a dashboard display and/or via smart glasses warn by the driver. This method 275 enhances situational awareness and safety by ensuring that drivers have a comprehensive view of their surroundings, even in the presence of physical obstructions.

While for purposes of simplicity of explanation, the respective processes are shown and described as a series of blocks in FIG. 2N, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one embodiment, the method 275 can be a location-based service that is not dependent on where a vehicle is currently located but rather is based on a particular location having a known blind spot or is an accident-prone area. For example, the service can be provided to any vehicles that drive into a particular area. In one embodiment, the service can be a UE-based service such that the alert, information or modeling generated from the collected sensor data that results in transparency being provided to an obscured view area is provided to UEs, such as to passengers in a vehicle. In other embodiments, the service can utilize the UE (such as belonging to a passenger) which then presents the alert, information or modeling via a vehicle computer system.

In one embodiment, the system and methodology can filter the sensor data from the camera to remove extraneous information unrelated to the potential hazard.

In one embodiment, the system and methodology can identify the sensor at a second location by querying a sensor database that stores location and orientation data of a plurality of sensors.

In one embodiment, the system and methodology can generate three-dimensional model by extrapolating a complete three-dimensional representation of a particular vehicle from LiDAR sensor data using artificial intelligence techniques.

In one embodiment, the system and methodology can monitor a driver's gaze by comparing a detected gaze (e.g., direction, time, or some other measurable metric) with a predetermined attention threshold (e.g., direction time, or some other measurable metric) to ascertain driver inattention.

In one embodiment, the system and methodology can provide data representing an alternate augmented reality display based on determining a non-existence of any vehicle within the obscured view area.

In one embodiment, the system and methodology can provide an alert by delivering tactile feedback via a haptic device and/or audio feedback via in-vehicle speakers responsive to the assessed level of driver inattention. This can be performed in conjunction with detecting a higher risk vehicle in an obscured view area or without such a detection.

In one embodiment, the system and methodology can present data representing a three-dimensional model by projecting the augmented reality display onto a window which can include a windshield of a vehicle.

In one embodiment, the system and methodology can transmit sensor data via a network node (e.g. an edge server) configured to integrate data from multiple vehicles and sensors in a mesh network.

In one embodiment, the system and methodology can calibrate the perspective of the augmented reality display based on the first vehicle's positional data and/or the driver's head orientation detected by the in-vehicle sensor.

The processing system communicating with the edge node server or other network device performing the analysis of sensor data can be done by an end user device within the first vehicle (e.g., a mobile App) that also communicates with a vehicle computer system of the first vehicle to obtain the first sensor data (i.e., the view from the first vehicle) and to provide the alert, data or three-dimensional model of the hazardous object which can be displayed via the vehicle computer system (e.g., on a window (including a windshield) or a display of the first vehicle).

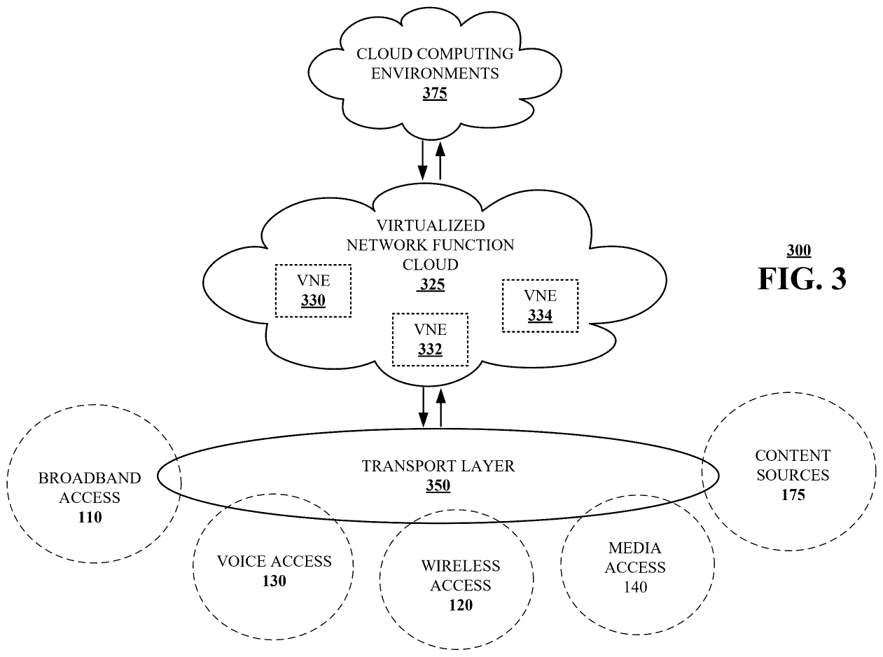

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A-2N, and 3. For example, virtualized communication network 300 can facilitate in whole or in part providing, to a server, first sensor data from a first sensor of a first vehicle at a first location, where the providing of the first sensor data enables the server to determine an obscured view area associated with the first vehicle; receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle. In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

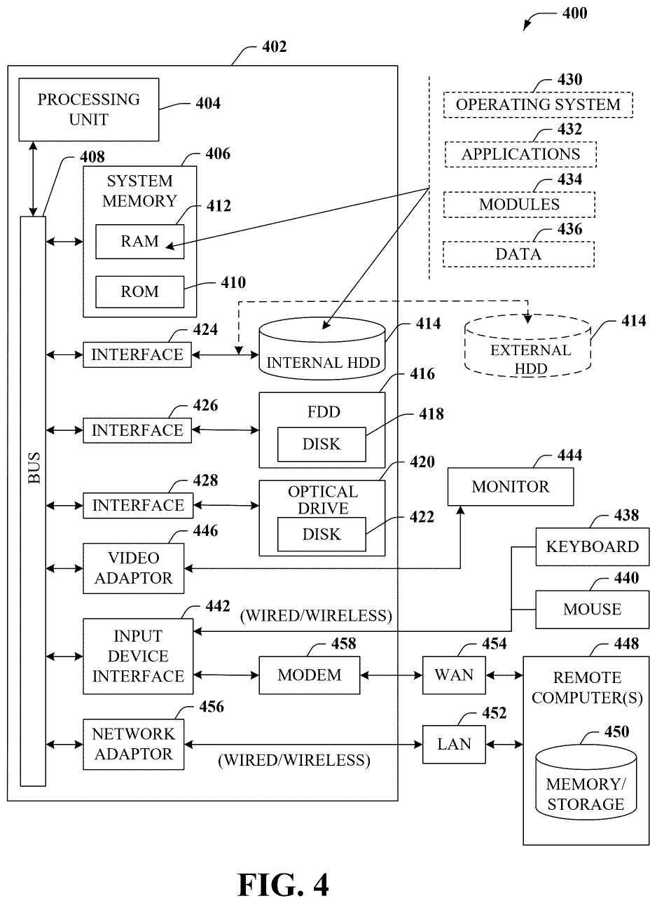

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part providing, to a server, first sensor data from a first sensor of a first vehicle at a first location, where the providing of the first sensor data enables the server to determine an obscured view area associated with the first vehicle; receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

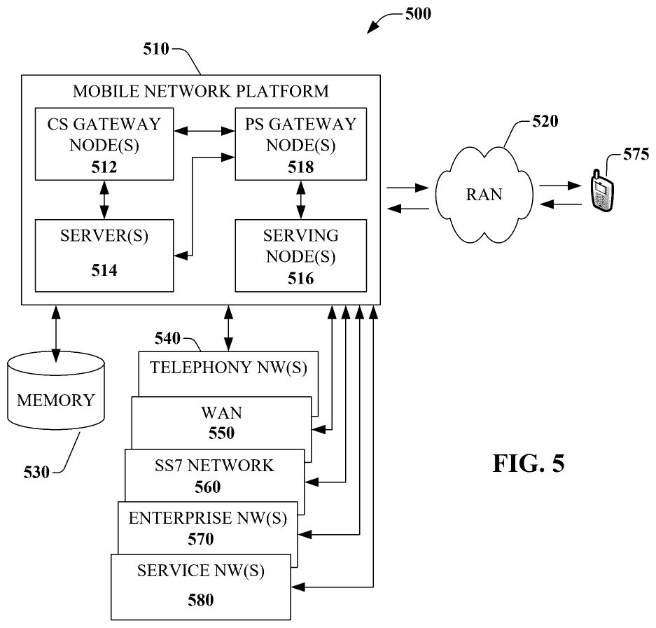

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part providing, to a server, first sensor data from a first sensor of a first vehicle at a first location, where the providing of the first sensor data enables the server to determine an obscured view area associated with the first vehicle; receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

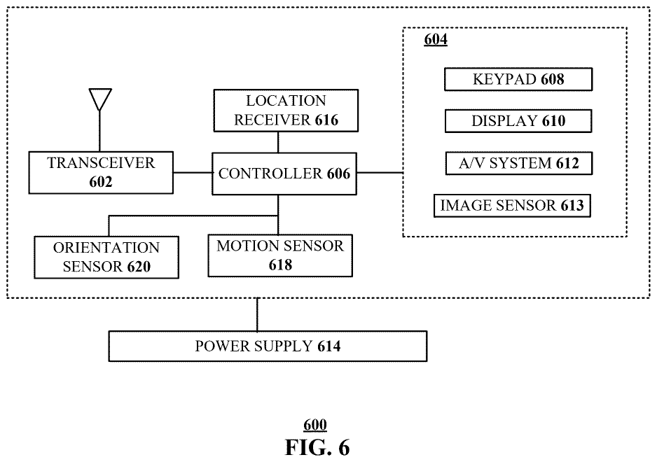

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part, providing, to a server, first sensor data from a first sensor of a first vehicle at a first location, where the providing of the first sensor data enables the server to determine an obscured view area associated with the first vehicle; receiving, from the server, an alert that is based on a detection of a hazardous object in the obscured view area, where the server detects the hazardous object by analyzing second sensor data of a second sensor that is identified by the server according to the first sensor data and according to a determination that the second sensor at a second location has an alternate view of the obscured view area; and presenting the alert at the first vehicle.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth® . The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth® , or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving first sensor data from a first sensor of a first vehicle at a first location;
analyzing the first sensor data;
determining, based on the analyzing of the first sensor data, an obscured view area associated with the first vehicle;
identifying a second sensor at a second location that has an alternate view of the obscured view area;
obtaining second sensor data from the second sensor at the second location;
creating a three-dimensional model of a second vehicle in the obscured view area based at least in part on the second sensor data; and
providing a representation of the three-dimensional model to a display device of the first vehicle for presentation at the first vehicle.

2. The device of claim 1, wherein the first sensor is a camera, and wherein the presentation of the three-dimensional model is on a window of the first vehicle at a window location corresponding to a line of sight of a driver to the obscured view area.

3. The device of claim 1, wherein the second sensor at the second location is a LiDAR sensor on a third vehicle, and wherein the alternate view for the LiDAR sensor is unobscured as to the obscured view area.

4. The device of claim 1, wherein the operations further comprise:
analyzing the second sensor data;
detecting, based on the analyzing of the second sensor data, a fourth vehicle;
determining a risk assessment with respect to the fourth vehicle, the first vehicle and the obscured view area; and
providing data representing the risk assessment to the first vehicle.

5. The device of claim 4, wherein the processing system operates as an edge network node of a network communication system, and wherein the operations further comprise:
obtaining information from a database to facilitate the identifying of the second sensor at the second location.

6. The device of claim 5, wherein the information from the database includes location information for one or more vehicles, mapping information associated with the obscured view area, or a combination thereof.

7. The device of claim 6, wherein the second sensor at the second location is one of a LiDAR sensor or a camera at a fixed location corresponding to the second location.

8. The device of claim 6, wherein the mapping information includes position information corresponding to a road in the obscured view area, and wherein the position information is used for creating the three-dimensional model.

9. A method, comprising:
receiving, by a processing system including a processor, first sensor data from a first sensor of a first vehicle at a first location;
analyzing, by the processing system, the first sensor data to determine an obscured view area corresponding to a potential hazard;
identifying, by the processing system, a second sensor on a second vehicle at a second location positioned to capture an alternate view of the obscured view area;
receiving, by the processing system, second sensor data from the second sensor at the second location;
analyzing, by the processing system, the second sensor data;
detecting, based on the analyzing of the second sensor data, a hazardous object in the obscured view area;
determining a risk assessment with respect to the hazardous object, the first vehicle and the obscured view area; and
providing data representing the risk assessment to the first vehicle.

10. The method of claim 9, wherein the hazardous object is a third vehicle, and further comprising:
generating, by the processing system, a three-dimensional model of the third vehicle based on the second sensor data; and
providing, by the processing system, via an augmented reality display associated with the first vehicle, data representing the three-dimensional model from a perspective corresponding to the first location of the first vehicle, wherein the perspective overlays a vehicle object corresponding to the third vehicle over the obscured view area.

11. The method of claim 10, wherein the augmented reality display includes a window of the first vehicle upon which the vehicle object is presented.

12. The method of claim 10, wherein a gaze of a driver of the first vehicle is monitored via an in-vehicle sensor, and where an alert comprising a tactile stimulus, an audio stimulus, or a combination thereof is presented at the first vehicle in response to a determination that the driver is determined to be inattentive to the hazardous object presented by the augmented reality display.

13. The method of claim 12, wherein monitoring of the gaze further comprises comparing a detected gaze direction with a predetermined attention threshold to calculate driver inattention.

14. The method of claim 9, wherein the first sensor is a camera, a LiDAR sensor, or a combination thereof, wherein the second sensor is a camera, a LiDAR sensor or a combination thereof, wherein the potential hazard is to the first vehicle, and wherein the potential hazard is another vehicle.

15. The method of claim 9, wherein the identifying the second sensor comprises querying a sensor database that stores location and orientation data of a plurality of sensors.

16. The method of claim 9, wherein the providing the data representing the risk assessment comprises generating a three-dimensional model including extrapolating a complete three-dimensional representation of the hazardous object from LiDAR sensor data of the second sensor data using artificial intelligence.

17. A non-transitory machine-readable medium, comprising executable instructions that, when executed by a processing system including a processor, facilitate performance of operations, the operations comprising:
providing, to a server, first sensor data from a first sensor of a first vehicle at a first location, wherein the providing of the first sensor data enables the server to determine an obscured view area associated with the first vehicle;
receiving, from the server, an alert that is based on a detection of a hazardous object in the obscured view area, wherein the server detects the hazardous object by analyzing second sensor data of a second sensor that is identified by the server according to the first sensor data and according to a determination that the second sensor at a second location has an alternate view of the obscured view area; and
presenting the alert at the first vehicle.

18. The non-transitory machine-readable medium of claim 17, wherein the presenting of the alert comprises:
providing, by the processing system, via an augmented reality display associated with the first vehicle, data representing a three-dimensional model from a perspective corresponding to the first location of the first vehicle, wherein the perspective overlays a vehicle object corresponding to the hazardous object over the obscured view area.

19. The non-transitory machine-readable medium of claim 18, wherein a gaze of a driver of the first vehicle is monitored via an in-vehicle sensor, and wherein an alert stimulus comprising a tactile stimulus, an audio stimulus, or a combination thereof is presented at the first vehicle in response to a determination that the driver is determined to be inattentive to the vehicle object presented by the augmented reality display.

20. The non-transitory machine-readable medium of claim 19, wherein monitoring of the gaze further comprises comparing a detected gaze direction with a predetermined attention threshold to calculate driver inattention.
